(19) United States
(12) Patent Application Publication
(10) Pub. No.: US 2008/0197619 A1
(43) Pub. Date: Aug. 21, 2008

(54) Pharmacy Printer Blank Sheet And Method For Avoiding Printer Misfeeds

(76) Inventor: Jim M. Tussey, Caro, MI (US)

Correspondence Address: JOHN R. BENEFIEL, 525 Lewis Street, BIRMINGHAM, MI, 48009, US

(21) Appl. No.: 11/676,045

(22) Filed: Feb. 16, 2007

(51) Int. Cl. B42D 15/00

(52) U.S. Cl. 283/81

(57) ABSTRACT

A two section pharmacy printer blank sheet for printing information text and labels for drug prescription drugs when dispensing prescription drugs and a method which reduces printer misfeeds in U feed printers to allow use of the simpler, more reliable U-feed printers to be successfully used for on site printing of the pharmacy printer blanks. The lower side of one of the labels is spaced closer to overlapped strip parts of the printer blank sections to reduce the tendency for one of the section edges to catch a lower side edge of the labels in a U-feed printer to minimize printer misfeeds.

### BACKGROUND OF THE INVENTION

This invention concerns printer label blanks and more particularly specialized pharmacy printer blank sheets particularly adapted for use in printing prescription drug labels. These pharmacy blanks, commonly called label blanks, have a plurality of separate and removable cut-labels adhered on a release paper stock primary section and a standard copy paper stock section bonded or glued to the primary section, resulting in a multi-thickness paper stock, both of which printed on by a laser-style printer located on site at the dispensing pharmacy.

The various labels are adhesively attached to an upper or primary section of the sheet having a smooth, waxy, silicone-based release surface to allow the labels to be easily removed after printing. The release paper section is attached to a lower or secondary bond paper section, where drug information text is printed, by adhesively secured overlapping strip portions at the adjacent ends of the respective sections.

This type of specialized printer blank is well known and is described in U.S. Pat. No. 5,855,395.

This basic configuration of a pharmacy printer blank is now well entrenched as special printing machines have been developed by the industry at great cost to handle the tricky task of manufacturing these two-part pharmacy printer blanks. Thus, making any substantial changes to the basic configuration of these printer blanks is not a practical option due to the high costs of redesigning the custom printing equipment needed to manufacture the pharmacy printer blanks.

Trouble free printing of these now standardized pharmacy printer blanks is critical to the pharmacy business, since malfunction of the printers at the pharmacy completely prevents the effective filling and dispensing of prescriptions until the printer is restored to service.

The most common type of laser printer which has been widely used for on site printing of the pharmacy printer blanks at pharmacies is the so called “S-feed” (with the good side of the pharmacy blank oriented downwardly) sheet path laser printer, which has the drawback of being prone to misfeeds and jamming of these special blanks in the pharmacy printers due to the complexity of the S shaped sheet feed path. There is also an increased risk of printer failure due to the complex components required to execute the S feed printing.

A newer second type of laser printer has an improved feed path, and it is commonly called a “U-feed” (good side of pharmacy printer blank oriented upward) printer, which has come into limited use for this application as it is inherently less likely to jam due to the simpler U-shaped sheet feed path. Also, the U-feed printers, having simpler components, are less likely to fail due to less complexity of the components used.

Despite the simpler U-feed sheet path and the less complex components of this type of printer, misfeed problems in feeding printer blanks of the type described have not been eliminated, but have actually been increased, because, while the U-feed is superior for standard or copy paper use, it is more sensitive to the variable paper thickness of the multisection pharmacy printer blanks used in pharmacies and jams almost instantly when presented with a standard pharmacy printer blank.

It is an object of the present invention to improve the reliability of one sided laser printing of the multisection pharmacy printer blanks incidental to dispensing prescriptions.

It is a further object of the present invention to simultaneously improve the printer sheet feed reliability of the multisection printer blanks used in prescription drug dispensing in both U and S feed printers utilizing an improved multisection printer blank enabling the pharmacy to stock only one pharmacy printer blank style which saves space and reduces operational complexity.

### SUMMARY OF THE INVENTION

In printer feed mechanisms, each sheet is driven off a stack of sheets by rotation of a friction wheel engaging the top sheet of the stack in the manner well known in the art, while simultaneously providing a friction method to retain all sheets below the engaged top sheet.

In the S-feed and U-feed printers, the sheets are fed differently so that one is printed from the bottom end and the other is printed from the top end of the sheet, i.e., in the S feed an inversion of the sheet is executed in preparation for printing.

The present inventor has discovered that the difference in the orientation of the sheet of the type described when being printed creates misfeeds of pharmacy printer blanks in the U-feed printers, yet will function adequately in an S-feed printer.

In the glued, lapped joint of the two section prescription label printer blank sheets, the end of the upper section trails the free end of the upper section when driven off the stack in the S feed printers so as to slide smoothly over the labels peelably adhered to the upper release section of the sheet next below in the stack so as to not create misfeeds

However, in the reverse side printing of the U-feed printers (with the good side of pharmacy printer blank oriented upwardly), the present inventor has discovered that the lapped edge of the lower section moves in a direction tending to catch, or lock, on to the protruding lower side of the adhered label edges of the pharmacy printer blank located next in the paper stack, which has adhered label edges which are conventionally oriented in alignment with each other. This results in a significant incidence of sheet misfeeds.

According to the present invention, in order to minimize this tendency, the lower side edge of at least one of the adhered labels is offset from the other label's lower side edges so as to be staggered relative to the remaining other label edges. This arrangement has been found to substantially reduce misfeeds in U feed printers since the leading lapped edge of the lower section initially encounters the lower edge of fewer labels of the label array on the next lower printer blank, thus reducing the contact surface area. Since this label contact area is much narrower than the collective length of all of the label lower side edges, the lapped edge can much more frequently be driven over and past that label lower edge without catching and misfeeding the sheet.

Restated in another way, the retaining frictional force, supplied by the printer driver, on subsequent labels is greater than the force that the top pharmacy label blank can create when it locks onto the next pharmacy label blank in the stack.

In turn, this has been found to greatly reduce the incidence of misfeeds in U-feed printers to allow their effective use in pharmacies, significantly improving the reliability of the printing of pharmacy label blanks.

### DESCRIPTION OF THE DRAWING FIGURES

FIG. 1 is a plan view of a prior art multisection pharmacy printer blank sheet of a type used in dispensing prescription drugs.

FIG. 2 is a side elevational view of a stack of prior art printer blank sheets shown with the various layers separated for clarity.

FIG. 3 is a diagrammatic view of an S-feed printer showing the sheet feed path and direction.

FIG. 4 is a diagrammatic view of a U-feed printer showing the sheet feed path and direction.

FIG. 5 is a plan view of the printer blank sheet for dispensing prescription drugs according to the present invention.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

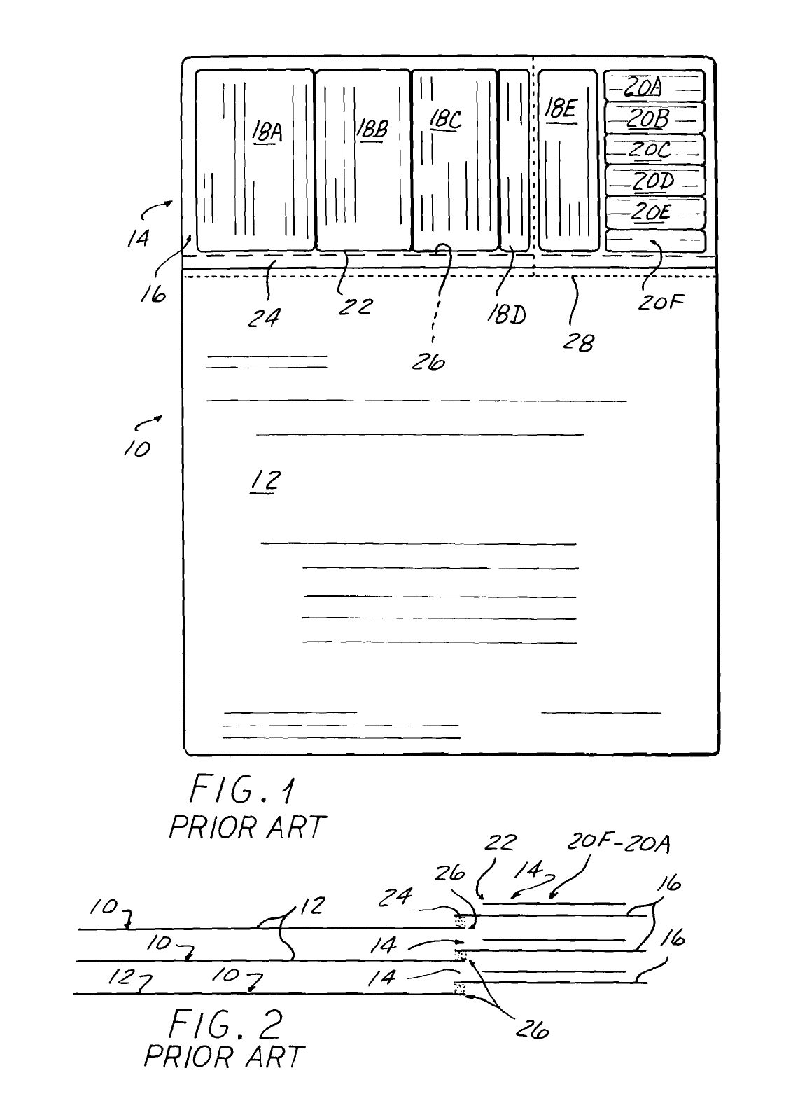

Referring to the drawings, and particularly FIGS. 1 and 2, a conventional printer blank sheet 10 for a combined prescription drug label and drug data sheet is shown. This includes a lower bond paper section 12 secured to an upper label maintaining section 14. The lower section 12 is to be imprinted by a printer with drug information text relating to the drug being prescribed in the well known manner.

The upper section 14 includes a release sheet 16 having an adhesive release surface which has a waxy finish to which are adhered a plurality of various sized pressure sensitive adhesive backed labels 18A-18E and similar special auxiliary stickers 20A-20E.

The label 18A is typically provided for the medicine vial, label 18B is a copy, label 18C is attached to the receipt, 18D for signature, and 18E is an extra for special use.

The auxiliary labels 20A-20E are typically used for attention getting special instructions, i.e. “Take with food”, for warnings, i.e., “Do not operate machinery when taking”, etc.

According to conventional practice, the lower side edges of labels 18A-18E and the bottom edge of auxiliary label 20F are all aligned with each other so as to form a substantially continuous edge 22 extending across the width of the sheet 10 and spaced above an overlay strip part 24 whereat the lowermost part of the release layer 16 overlaps the uppermost strip part of the lower section 12.

A conventional heat set adhesive is used to join these sections together to form the composite pharmacy printer blank sheet 10.

The lower section 12 is typically perforated along a line 28 extending across its width for easier tear-off.

The topmost part of the lower section 12 lies beneath the bottommost strip of the release sheet 16 such that the exposed upper edge 26 (FIG. 2) lies below the release sheet 16.

The exposed upper edge 26 is spaced down from the edge 22 formed by the aligned labels 18A-18E and 20A-20F so that a gap exists between the edges 22, 26 when the printer blank sheets 10 are stacked as indicated in FIG. 2.

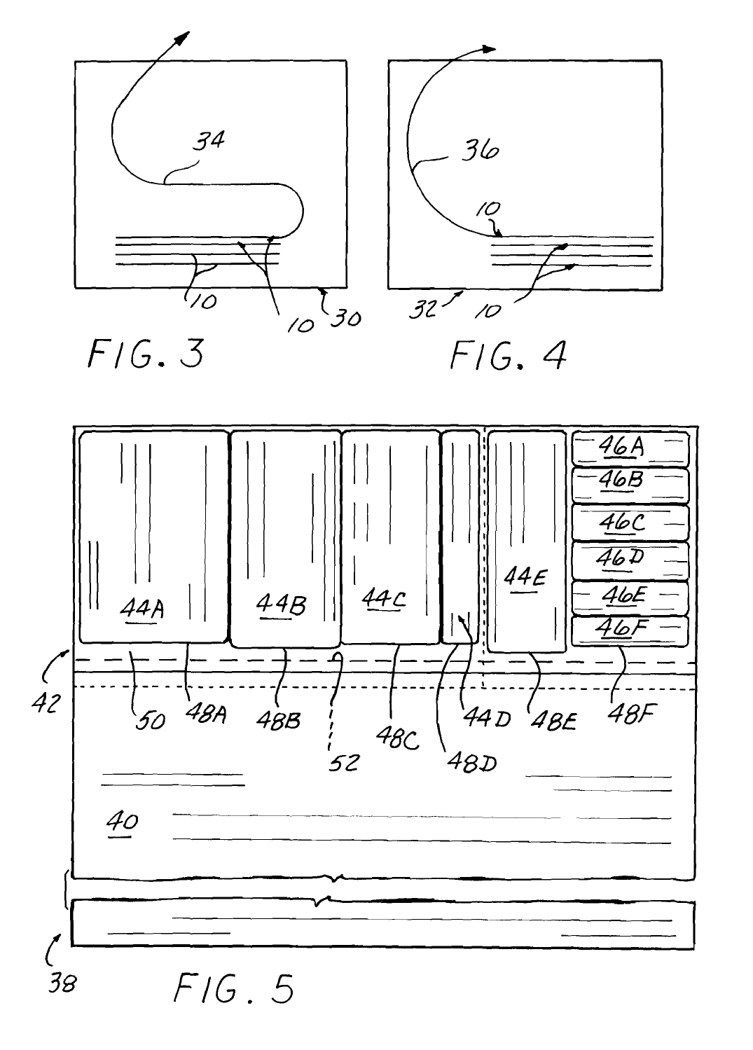

FIGS. 3 and 4 are diagrams of an S-feed printer 30 and a U-feed printer 34, respectively.

In the S-feed printer 30, each sheet 10 driven off the stack is advanced horizontally to the right and then reversed twice along the S path 34 as indicated in order to accommodate the particular printing mode employed.

In the U feed printer 32, each sheet 10 driven off the stack is advanced to the left and then is reversed only once to form the U path 36, using a different printing mode.

The stacks of sheets must be oriented in the same way in each type of printer to be properly printed.

In the S feed path 34, the edges 22, 28 separate as the top sheet 10 is advanced to the right as viewed in FIG. 3.

Contrariwise, in the U feed printer 32, the edges 22, 26 move towards each other, and this creates a tendency for these edges 22, 26 to catch on each other, and when this happens, a paper jam and misfeed will often result.

FIG. 5 shows a two section printer blank sheet 38 according to the present invention which greatly mitigates the tendency described.

The basic configuration of the printer blank sheet 38 according to the invention is similar to the conventional printer blank sheet 10 described above.

A lower bond paper section 40 is attached to an upper label mounting section 42. The upper section 42 is comprised of a sheet material having a waxy release surface to which is peelably adhered a series of labels 44A-44E and a series of auxiliary labels 46A-46F as in the conventional printing blank described above.

However, the lower edges 48A-48F of the labels 44A-44E and the auxiliary label 46F are offset from each other to stagger these edges 48A-48F from each other.

Preferably, the narrowest label 44E is closest to the bottom to be the leading label edge during feeding.

A lapped strip 50 presents the upper edge 52 of the lower section 40 beneath the lowermost part of the upper section 42.

It has been found that this staggering of at least one of the label edges 48A-48F greatly reduces the tendency of the label edges to catch on edge 52 and misfeed in U feed printers to provide an overall increased in reliability over S feed printers.

This is believed to result because the edge 52 of the topmost printer blank 38 can much more easily be driven past the much shorter edge of a single label if catching does occur. Once atop that label, the sheet edge 52 is elevated to be above the other label edges to prevent repeated catching of the edge 52 on other label edges.

At least one of the labels has its lower side edge located to lead the other label lower side edges, although preferably more than one label lower side edges is offset from other label lower side edges as shown.

At the same time, this blank 38 can also be reliably used in S-feed printer without any tendency to misfeed.

1. In a printer blank sheet for use in printing drug prescription labels and drug information text comprised of a lower section of printable bond paper and an upper section having an adhesive release surface on which a row of pressure adhesive backed labels are affixed, said upper and lower sections having overlapped contiguous strip parts attached together, the improvement wherein a lower side edge of at least one of said labels adjacent said overlapped strip parts is offset to be located closer to said overlapped strip parts than the lower side edges of other labels held on said upper section of said printer blank sheet.

2. The printer blank sheet according to claim 1 wherein several of said labels each have a lower side edge spaced a different distance from said overlapped edges from other of said labels.

3. A method of reducing printer misfeeds of printer blank sheets for prescription drug labels which are advanced from a stack of said printer blank sheets in a U feed printer, said printer blank sheet comprised of a lower printable section and an upper adhesive release faced section having a plurality of blank labels adhered thereto, said upper and lower sections having overlapped strip parts adjacent contiguous edges, comprising offsetting the lower side edge adjacent said overlapped strip parts of at least one of said labels adjacent said overlapped edges to be at a shorter distance from said overlapped edges than lower side edges of the other labels.

4. The method according to claim 3 including spacing the lower side edge of several of the labels at difference distances from said overlapped strip parts.
